(19) United States
(12) Patent Application Publication
(10) Pub. No.: US 2010/0318388 A1
(43) Pub. Date: Dec. 16, 2010

(54) Native American Indian Compliant Financial Services Methodology

(76) Inventor: Jeremy E. Gauld, (US)

Correspondence Address: Jeremy Gauld, 20 Fairfield Street, Cambridge, MA, 02140, US

(21) Appl. No.: 12/481,698

(22) Filed: Jun. 10, 2009

(51) Int. Cl. G06Q 40/00; G06Q 10/00

(52) U.S. Cl. 705/7; 705/30; 705/35; 705/37

(57) ABSTRACT

A financial services method formulated in accordance with the principles of the current invention supports the implementation of certain Native American Indian compliant financial instruments that are beneficial for trading and possess like qualities to those traded on traditional markets. A financial association is created under which the parties in the system take on several financial responsibilities in high-quality financial offerings. The financial services system will provide an institutional mechanism for the worldwide implementation of Native American Indian guiding principles and policies as policed by a centralized Native American Indian Compliance Office, a Native American Indian auditing and supervising organization. Such a Native American Indian compliant financial structure would prohibit the imposition of foreign levies on activities on Native American Indian sovereign lands, thus enabling the successful implementation of an operational mechanism possessing a pecuniary effect similar to traditional fiscal products that would regularly be precluded under Native American Indian financial guiding principles. Such a method will spawn the maturity of a centralized worldwide Native American Indian financial marketplace purposefully formulated with respect to the monetary services requirements of the participating financial services organizations in bringing financial opportunities to the Native American Indian investment economy for placement.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The current invention relates to a financial services methodology in support of the realization of various Native American Indian compliant financial instruments.

### BACKGROUND OF THE INVENTION

Political instability, economic insecurity and financial services risk outside of the United States has created incentives for the transfer and investment of nonresident alien capital derived from legitimate estates and business activities to financial services organizations and other safe havens. It is in the interest of Native American Indian Tribes to attract such nonresident alien capital for investment, revenue enhancement and other economic maturity purposes and to provide business and employment opportunities for Native American Indians. Native American Indian Tribes have authority as sovereign governments and under their powers to manage economic maturity within their reservations to provide economic opportunities limited to Native American Indians and to treat nonresident aliens differently than others with respect to equal protection of the law. Because the Internal Revenue Code of the United States (Title 26 of the United States Code) prohibits Native American Indian Tribes from offering the type of tax shelters to United States investors that are available to them in non-United States jurisdictions, and because very few of the conditions prevalent in other countries that give rise to capital flight exist in the United States, Native American Indian Tribes are uniquely situated to offer specialized private financial services exclusively to nonresident alien investors. Native American Indian Tribes have the competence, capacity and legitimate authority to charter and regulate financial services organizations located on their reservations. A prudent blend of financial privacy, asset protection and profitability may offer nonresident alien investors unique opportunities to build and preserve wealth in cooperation with the Native American Indian Tribes.

Congress and the United States Supreme Court have long recognized that Native American Indian Tribes possess inherent sovereignty that antedates the existence of the United States. See e.g., Worcester v. Georgia, 31 U.S. (6 Pet.) 515, 581 (1832); Cherokee Nation v. Georgia, 30 U.S. (5 Pet.) 1, 17 (1831). Thus, Native American Indian Tribes possess inherent power to exclude nonmembers from their jurisdictions and “general authority, as sovereigns, to control economic activity” therein. See, Merrion v. Jicarilla Apache Tribe, 455 U.S. 130, 137 (1982). Accordingly, it is well formulated that Native American Indian Tribes posses authority “to manage the use of their territory and resources by both members and nonmembers . . . [and] to undertake and regulate economic activities within the reservation[.]” See, New Mexico v. Mescalero Apache Tribe, 462 U.S. 324, 335 (1983) citing, inter alia, Merrion, supra. In particular, for Native American Indian trust lands within reservations, the United States Supreme Court has consistently reaffirmed that Native American Indian Tribes possess civil authority over the actions of all people, Indians and non-Indians alike. See Kerr-McGee vs. Navajo Tribe of Indians, 471 U.S. 195 (1985); Merrion, supra; see also Montana v. United States, 450 U.S. 544, 557 (1981)(“readily agree[ing]” that a tribe may regulate nonmember conduct on Native American Indian Tribal land); Strate v. A-1 Contractors, 117 S.Ct. 1404, 1413 (1997)(reaffirming per Montana supra that “tribes retain considerable control over nonmember conduct on tribal land”). Finally, Native American Indian Tribal sovereignty extends to all traditional governmental functions, not merely those historically engaged in by Native American Indian Tribes. See, Indian-Country, U.S.A., Inc. v. Oklahoma Tax Comm'n, 829 F.2d 967, 982 (10th Cir. 1987) (concerning gaming regulation), cert denied, 487 U.S. 1218 (1988); Cabazon Band of Mission Indians v. County of Riverside, 783 F.2d 900, 906 (9th Cir. 1986) (concerning same; also noting sovereign tribal authority for zoning and automobile registration), aff'd sub nom., California v. Cabazon Band of Mission Indians, 480 U.S. 202 (1987); see Blackcountry Against Dumps v. U.S. E.P.A., 100 F.3d 147, 151 (D.C. Cir. 1996)(recognizing sovereign tribal authority over solid waste disposal); N.L.R.B. v. Pueblo of San Juan, 30 F. Supp. 2d 1348 (D.N.M. 1998)(recognizing sovereign tribal authority to prohibit union-security agreements).

Native American Indian, as compared to, non-Native American Indian venture practices have existed as completely self-governing and essentially distinct finance and investment systems for many years. In Native American Indian economies, Native American Indian investment guiding principles and rules are effectuated which are undoubtedly followed by Native American Indian organizations. Native American Indian investment guiding principles and regulations reference Native American Indian decrees concerning fiscal products and pecuniary speculation within the Native American Indian society. As such, the economy of Native American Indians has been limited through its support of investments and projects that only meet strict conformity with Native American Indian investment guidelines. Similarly, the capital markets, investment banking and venture capital markets of non-Native American Indians have historically been serviced by operating within their various, well-established industries. These fiscal services industries have expanded into a worldwide prevailing force with respect to financial services power and asset management industry volumes, thus acting as the standard in such capital-based practices and procedures in the world.

The Native American Indian economy possesses significant profundity and fiscal capabilities that can potentially generate an important financial existence within the global financial system. With respect to the well-established banking, financial services and investment markets as compared to those of Native American Indians, there exist various essential contributing reasons why the Native American Indian markets have been relatively isolated from the worldwide capital markets. The Native American Indian financial population must adhere to a general requirement that every potential investment be in strict compliance with Native American Indian investment guidelines. In addition, there does not exist a formulated, networked mechanism for Native American Indian monetary activities that permits financial organizations to work conterminously with a standardized fiscal plan in an efficient manner across jurisdictional boundaries. Also, Native American Indian financial organizations have not been motivated to engage in traditional fiscal rating and reporting systems. Lastly, the Native American Indian market needs a fully operational fiscal exchange that will assist in the more free flow of assets between financial organizations, therefore improving the investor returns and liquidity. Overall, the primary basis of Native American Indian investment that differentiates Native American Indian fiscal practices from those, more well-established practices, is the requirement to partake and participate in investment opportunities that adhere to Native American Indian beliefs, guiding principles and law.

It is prudent to even the financial playing field with respect to these two differing cultures that exist as stand-alone economic and investment systems. The development of a process that would generate synergy between the Native American Indian and well-established, traditional investment philosophies is the projected increase in the availability of capital into the Native American Indian economies from the mainstream financial marketplace. Such a symbiosis has not yet been obtained on a consistent basis.

In the traditional markets, there exist numerous well-established financial products that are readily identifiable and processed by the industry without the requirement for novel, fiscal-specific operational assistance and support. As a result of its impressive history of organizational infrastructures, the traditional markets are equipped to produce and promote the growth of various types of financial instruments. Additionally, current financial processes and structures that provide for the management and trading of such financial instruments (i.e., generally accepted clearing practices, organizational lending efforts, credit ranking and rating frameworks, reporting schemes, etc.) are not readily prevalent, or even available, for Native American Indian compliant financial products. These systems significantly assist in the development of the key components of financial returns and liquidity, and drive the traditional markets to generate market efficiencies.

For the Native American Indian economies to create advanced offerings that appeal to nonresident aliens, the Native American Indian financial services industry must not only effectuate and encourage the development of novel financial devices, but also must provide the foundational support for managing infrastructure to allow the utilization of such products given the Native American Indian requirements. This can be accomplished through a coordinated, internet-based institutional and banking system. Also, there does not exist a solution for the limited duration liquidity needs of one financial organization with the monetary assets of others. There is also no recognizable method of reselling an investment in rapid manner to a qualified counterparty as such monetary instruments can vary to a significant extent with respect to form and function. Additionally, there does not exist a standardized communications methodology purposefully designed to the requirements of the Native American Indian financial markets such that Native American Indian compliant operation mechanisms and methods can be deployed in a truly efficient manner.

The establishment of a financial services and banking industry designed to meet the particular requirements of the Native American Indian investment and financial services economy such that it will encourage qualified Native American Indian investment organizations to work conterminously with other qualified institutions. An integral communications structure will enable Native American Indian financial services organizations, utilizing a standardized platform of methods and functions, to generate marketplace efficiencies, greater liquidity, investment returns and profit opportunities. In addition, such a structure has the potential to act as an extension of the operation of the auditing and overarching principles and requirements of Native American Indian permissible investments.

Another factor in advancing the maturity of an inter-bank system within the Native American Indian financial market is the need for the creation of a platform under which Native American Indian industry participants can be evaluated with respect to generally accepted practices and standards. Traditionally, there has not been a requisite amount of benefit to financial organizations, with respect to the relationship between those associated with Native American Indian entities and more traditional organizations, to motivate Native American Indian organizations to produce the required disclosures to enable such methodology. As such, there has been a dearth of motivation for Native American Indian financial organizations to engage in the various activities needed to participate in the established financial rating and reporting systems over time. Yet given the current worldwide economy, risk management and assurance with respect to products are inherent to success, and should be dealt with to ensure prudential, long-lasting operations through uniformly structured disclosures.

The possible advantages of producing such financial disclosures can be potentially offset by the potential risks of such disclosed information becoming utilized in a detrimental manner and readily available to the revealing party's competition. Even such disclosures would significant assist in the strength and performance of a Native American Indian financial organization as has benefited traditional financial entities, there has not been anything to tip the balance to favor the production of such disclosures by Native American Indian financial organization. As such, Native American Indian fiscal entities have little reason to engage in the disclosure and reporting consistent with well-established market practices. Therefore, if Native American Indian organizations are going to be coaxed to participate, the remuneration of active engagement must be explicitly clear.

In addition to monetary-based motivations, the ease of providing such information and disclosures is crucial for the successful implementation and use of reporting practices by Native American Indian financial organizations. Such standards of disclosure relating to Native American Indian entities ideally will extend past standard fiscal models to incorporate Native American Indian compliance-based reporting. Additionally, such requirements should encourage the development of a rating process that not only accounts for fiscal strength and standing, yet also for evaluation with respect to compliance with Native American Indian guidelines. Currently, there does not exist a reporting methodology widely and successfully implemented that has produced uniform engagement with respect to issuers of performance and Native American Indian compliance by Native American Indian entities. Until this system is put into place, the Native American Indian investment marketplace will stay inherently incompatible with traditional fiscal practices within the well-established framework of the traditional global markets. Also, the Native American Indian economy will, in all likelihood, remain unwilling or unable to coordinate monetary interests and products within an inter-financial organization philosophy.

During this critical, infant time in the maturity of the Native American Indian financial industry, the Native American Indian exchange is distinctly fragmented in determining the most appropriate method in which to create a verifiable Native American Indian financial marketplace. There does not exist a system properly designed to meet the requirements of Native American Indian financial and banking services entities with respect to the development of an electronic marketplace for monetary instrument offerings and the growth of appropriate investments for placement and investment by nonresident aliens.

The generation of such a market should be spawned by the relationship of the essential financial industry participants that possess a certain amount of power and authority amongst the Native American Indian economy. A successful operation of a worldwide Native American Indian marketplace would demarcate a line between improved efficiencies of regular operations of the participating entities and furthering market liquidity and profitability derived from Native American Indian participations. This causal link would effectuate the efficient and ready purchase, sale or trade of financial investments or obligations, thus acting to generate liquidity in the capital markets between participating organizations, and generating investor alpha and liquidity. A worldwide marketplace is required for the Native American Indian financial services industry to proceed to a greater level of economic advancement.

Therefore, a financial services system is needed that will provide qualifying financial services organizations the ability to engage in Native American Indian compliant offerings by nonresident alien investors in accordance with uniformly mandated financial products with increased efficiency. Such a system will afford a way in which to permit participating entities to sell and issue compliant offerings in an increased and accelerated way. Preferably, this financial services methodology will spawn the formation of a Native American Indian investment marketplace that is more liquid in nature. Such a system will encourage a stream of nonresident alien capital assets into the Native American Indian economy, thus creating the marketplace dichotomy that is prudent to generating institutional, volume investment. This financial services process will provide an institutional mechanism for the worldwide implementation of Native American Indian guiding policies and principles as policed by a centralized Native American Indian Compliance Office, a Native American Indian auditing and supervising organization. Such a system will also provide financial motivation to organizations to participate in the required financial disclosures reporting and Native American Indian compliance in line with global practices so that a credit and financial rating system purposefully tailored to the Native American Indian financial entity can be developed therefrom. This financial services methodology will encourage the maturity of a centralized, worldwide Native American Indian financial services marketplace purposefully formulated to appeal to the financial requirements of the participating institutions, banks and underlying nonresident alien investors.

Such a standardized system is needed such that it may be utilized with respect to private placement, investment banking and capital markets transactions to facilitate and promote the placement and sale of debt and equity instruments to fund various ventures, projects and investment vehicles. Such a system should bring together the tribal, cultural and investment criteria differences inherent in Native American Indian consideration of financial packages, capital markets offerings and other forms of investment opportunities. In addition, these novel practices should bridge what has traditionally been seen as greatly conflicting and divergent investment principles and philosophies; being the considerations of nonresident alien investors, which must consider the appropriateness of any investment with respect to recognized Native American Indian guiding principles in advance of any consideration being provided to a profit-based evaluation of the offering, and the well-established, yield driven models that serve as the foundation of conventional capital markets and investment decisions.

### SUMMARY OF THE INVENTION

A financial services method developed in line with the standards of the current invention will provide nonresident alien investors the ability to invest in Native American Indian compliant financial offerings through the utilization of homogeneous monetary products instruments with increased efficiencies. A financial services system created given the principles of this invention shall enable a way in which to permit participating entities to sell and issue financial offerings in promotion of their own liquidity and investment requirements which may be invested by nonresident aliens on an accelerated manner. This methodology created with the principles of this invention will spawn the formation of a liquid Native American Indian investment economy. Such a financial services system created with the principles of this invention will encourage the flow of nonresident alien capital investment into the Native American Indian economy to formulate the dynamic marketplace that benefits institutional, volume investment. Such financial services methodology created with the principles of this invention will afford an institutional mechanism for the worldwide implementation of Native American Indian guiding policies and investment principles as established by a Native American Indian Compliance Office, a Native American Indian auditing and supervising organization. Such a system created in accordance with the principles of this invention shall provide financial incentive to financial institutions to participate in financial and credit reporting standards, as well as, Native American Indian compliance guiding principles consistent with globally accepted standards such that a credit and financial rating methodology can be developed. Such a financial services system will spawn the growth of a centralized, worldwide Native American Indian financial services marketplace purposefully formulated to appeal to the financial requirements of the participating institutions, banks and underlying nonresident alien investors.

A financial services methodology formulated in agreement with the standards of this invention encourages the realization of various Native American Indian compliant monetary instruments that are beneficial for trading and possess like qualities to those sold on traditional markets. Further, such a Native American Indian compliant financial structure which does not permit for the imposition of foreign levies on activities on Native American Indian sovereign lands, enables the operation of a operation mechanism having a pecuniary effect similar to a conventional securitization or financial enhancement that would otherwise be precluded under Native American Indian financial guiding principles. Financial services practices designed in accordance with the current invention generate a standardized, internet-based communications and electronic messaging system that will provide administrative support of the newly-formed institutional financial services association. Such system will promote financial offerings that have the ability to generate more significant market returns, liquidity and efficiencies for participating financial entities and underlying investors. A financial services system designed in line with the principles of the current invention will promote the efficient underwriting, issuance and placement of approved monetary offerings in between qualifying financial services organizations. A financial services method developed in line with the standards of the current invention will enable the underwriting and issuance of Native American Indian compliant monetary offerings to facilitate and promote the placement and sale of debt and equity instruments to fund various ventures, projects and investment vehicles.

Predominately, in one embodiment a financial services system developed in line with the standards of this invention will spawn a centrally-located infrastructure to the operations of Native American Indian financial entities' investment practices. Such a financial services methodology is created that banking transactions and financial services can be effectuated in an electronic manner with consideration provided to Native American Indian compliant standards with respect operational matters. The financial services system may incorporate an internet-based communications and messaging process in promotion of the formulation of a Native American Indian financial entities association. The method model, via an engineered design of internet-based communications, settlement models and administrative practices, overseen by a Native American Indian Compliance Office, can generate a centralized mechanism to the management and interplay of Native American Indian financial organizations monetary practices. Participating financial institutions and banks and underlying investors will participate in detailing and tracking monetary proceeds from initial subscription to return with respect to each offering and organization. An internet-based data compendium which lists each offerings' history, with respect to investment returns and matters pertaining to Native American Indian compliance, will be produced and maintained. Such a system will spawn the growth and development of a worldwide Native American Indian financial services marketplace purposefully formulated to appeal to the financial requirements of the participating institutions, banks and underlying nonresident alien investors.

Particularly, in one embodiment a financial services method developed in accordance with the principles of the current invention will necessitate the assembly of a Native American Indian Compliance Office to review proposed financial instruments as to Native American Indian investment compliance. The Native American Indian Compliance Office, acting under the direct authority of each participating Native American Indian Tribe's sovereign realm and authority, shall serve as a clearinghouse with respect to financial instruments and provide relevant expertise for and perform ongoing, daily administrative supervision of participating entities. Each Native American Indian Compliance Office shall be staffed by experts in the area of the business operations of financial services organizations, predominately with respect to matters concerning Native American Indian finance, namely, jurisdictional and tax-based sovereignty through the prohibition of the imposition of foreign levies on Native American Indian lands.

A financial services process formulated with respect to the standards of the current invention brings together the cultural and tribal disassociation between Native American Indian and traditional investment market requirements. A financial methodology developed in accordance with this invention serves to advance the adoption of international rating and reporting standards by participating Native American Indian financial organizations in an economic, reasonable and efficient manner while also providing for Native American Indian investment compliance and associated governance matters to be simultaneously reported and reflected in the system. A financial services system implemented in line with the bases of this invention promotes the birth of a financial and credit rating system for the Native American Indian marketplace that will provide for the evaluation of investment opportunities and institutions given compliance with applicable Native American Indian guidelines and financial strength, thus enabling performance-based measures of the Native American Indian financial market to be quantifiable and measurable in line with universal investment practices utilized by the well-established market rating mechanisms. The current invention establishes a mechanism for Native American Indian compliant investments that will keep with traditional financial norms so that institutional, volume offerings may be promoted and cultivated within the international nonresident alien community. The successful utilization of the current invention will afford the Native American Indian investment community the power to rely on recognized and impartial entities for financial services evaluation and on-going Native American Indian compliance of the organization or investment, thus providing the underlying investor with the benefits of only having to perform a cursory evaluation of each offering organized with respect to the standards of the current invention.

A financial services method formulated in line with the objectives of the current invention will promote greater liquidity for financial services organizations and investors through the nurturing of institutional placement utilizing a uniformly structured financial instrument which is beneficial to the maturity of a secondary exchange, thereby promoting the flow of nonresident alien capital investment into the Native American Indian economy. A financial services method developed in accordance with the principles of the current invention will promote the growth of a Native American Indian securities specific marketplace whereby the participating organizations will serve critical responsibilities as registered marketplace members. In summary, the current invention provides for the establishment of an improved, efficient and manageable Native American Indian investment marketplace and institutional financial services, investment functions and banking than current practices allow.

### BRIEF DESCRIPTION OF THE DRAWINGS

FIG. 1 shows a schematic overview of the institutional investment practices of the traditional markets of the prior art.

FIG. 2 schematically demonstrates a financial services methodology in accordance with the current invention.

### DETAILED DESCRIPTION OF THE INVENTION

A financial services method formulated in line with the objectives of the current invention is intended to afford a methodology to assist the implementation of certain Native American Indian compliant financial instruments. A financial services method formulated in line with the objectives of the current invention is intended to offer an assimilation of the actions, practices and principles to assist such Native American Indian compliant financial instruments. The objectives of the current invention are also applicable to other financial products and instruments as well.

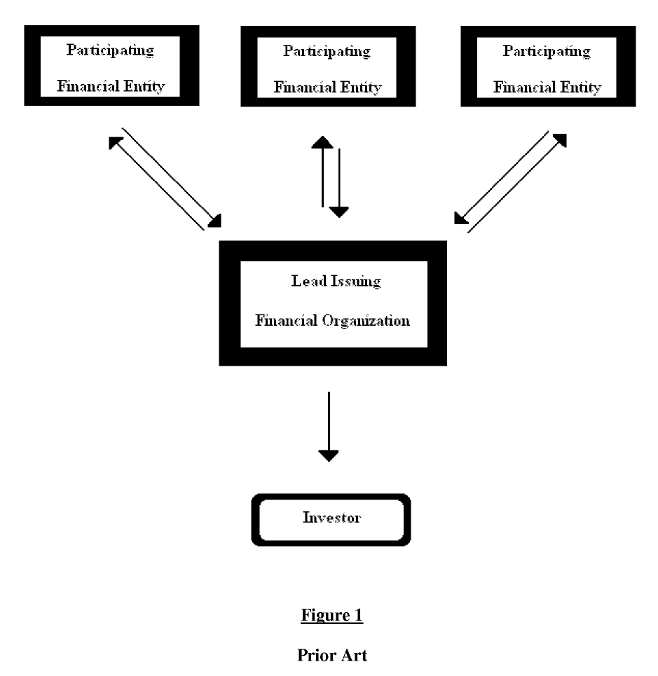

An institutional association between financial services organizations in line with the current invention possesses a positive and constructive effect on the participating financial organizations in the same way conventional institutional investment activities do in the traditional marketplace. Traditional industry activities in this respect are relatively straightforward and simple in producing liquid capital to engaging financial organizations. Referring to FIG. 1, the institutional investment practices of the traditional markets allow for an extremely straight, effectual and financially efficient manner with respect to the duties of participating financial organizations. The lead issuing financial organization offers its financial instrument backed by its exemplary credit and financial rating, thus providing proceeds and yield to the underlying investor. The credit and financial rating of the financial instrument is then the manner in which such security is marketed and resold by investors, providing a measure of liquidity in the investment marketplace.

In its most basic form with respect to the traditional industry marketplace, a financial services institution distributes a uniform financial instrument, product or security that is supported by a recognized distributor or issuer (as rated by Fitch, Inc., One State Street Plaza, New York, N.Y., 10004 (“Fitch”), Standard & Poor's, 55 Water Street, New York, N.Y. 10041 (“S&P”), Moody's Investors Service, Inc., 7 World Trade Center, 250 Greenwich Street, New York, N.Y. 10007 (“Moody's”) or another renowned and qualified rating organization). Such a rating encourages a liquid, cooperative trading exchange. This process is missing with respect to a Native American Indian compliant financial capital market in that monetary liquidity is irregular and volatile. Being that traditional industry financial activities are essentially incompatible with Native American Indian investment guidelines and practices, the current invention formulates a way in which the principle foundations of Native American Indian financial guidelines and practices are followed in a plan of uniform management systems that are beneficial to the distribution and purchase of quality financial instruments.

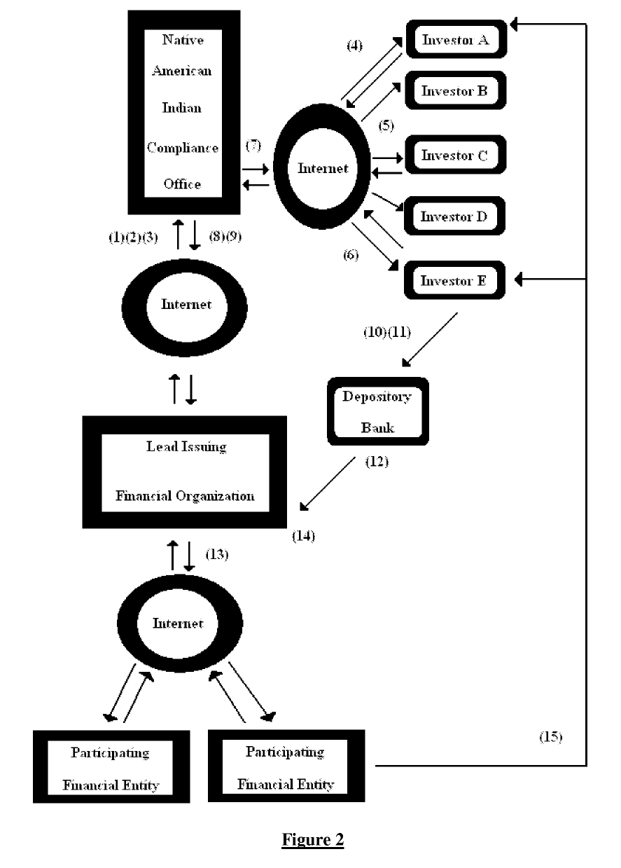

Referring to FIG. 2, a schematically drawn summary of a financial method developed in conformity with the current invention is shown. The lead issuing financial organization finalizes the list of planned participating financial organizations and the financial instrument is offered for purchase by qualified nonresident alien investors (4). Offering circulars and other pertinent disclosures and documentation is provided to interested nonresident alien investors (5). Such investors that wish to subscribe for interests of the financial instrument then supply their investment purchase offer via the internet, which includes a completed purchase and subscription agreement (6). Investors will not be assured to receive any of the applied for interests in the financial instruments, which is subject to approval and confirmation by the Native American Indian Compliance Office and the lead issuing financial organization.

The purchase offers are collected by the Native American Indian Compliance Office (7). Through the use of such networked infrastructure, the Native American Indian Compliance Office computes and delivers to the lead issuing financial organization the planned subscription proceeds from each proposed investor by considering numerous threshold standards for investment, including, but not limited to: prior trading in historical offerings, financial standing and liquidity to fund such potential subscription, compliance and auditing criterion and various other considerations in order to distribute a particular number of interests to each investor. The final investment allotments are then set forth by the lead issuing financial organization for final approval by the Native American Indian Compliance Office (8). The Native American Indian Compliance Office identifies any planned investors which it believes violates certain investment standards or principles (9). Requisite alterations are effectuated, if any, to the list of financial instrument interests allotment; subsequently the closing allotment is distributed to the investors, requesting delivery of sufficient currency to the depository bank in accordance with the requirements of the purchase and subscription agreement (10). Investors then move the requisite currency to the depository bank (11). Such funds are collected by the depository bank in a segregated depository bank reserve account and a receipt of such currency is duly noted (12). An appeal is formulated for resolution of applicable placement agency fees and expenses related to the purchase, as delivered to the lead issuing financial organization (13).

The lead issuing financial organization settles any relevant charges against its collection of investment proceeds received from investors (14). The financial instrument interests that are qualifying Native American Indian compliant financial instruments are then distributed to the subscribing investors (15).

The financial services method of the current invention establishes a system whereby financial services organizations shall be prompted by financial collateralization and compensation to participate in cohesively utilizing their respective financial powers. This will likely be achieved through a multi-faceted advance in the industry whereby a system of underwriting financial organizations collectively work to offer, distribute and sell qualifying financial instruments. Such market participants in the system take on various financial tasks with respect to the investment grade financial instruments in advance of bringing an offering to the Native American Indian economy for placement. Such a model, operated through a system of internet-based computerized messages, settlement procedures and management practices, overseen by a Native American Indian Compliance Office can centralize the requisite infrastructure to the activities of Native American Indian financial institutional investment practices. Participating financial organizations, nonresident alien investors and industry banks will engage in monitoring and disclosing investment revenues from offering through sale with respect to personal subject financial instruments or organizations. An internet-based catalog that sets forth financial instruments' returns and compliance with respect to matters relating to Native American Indian investment guidelines and practices will develop. This financial services methodology will encourage the maturity of a centralized, worldwide Native American Indian financial services marketplace purposefully formulated to appeal to the financial requirements of the participating institutions, banks and underlying nonresident alien investors.

The doctrines of the current invention will prompt the formation of a Native American Indian Compliance Office to evaluate planned financial instruments as to Native American Indian investment compliance. The Native American Indian Compliance Office, acting under the direct authority of each participating Native American Indian Tribe's sovereign realm and authority, shall serve as a clearinghouse with respect to financial instruments and provide relevant expertise for and perform ongoing, daily administrative supervision and audit of participating financial organizations and associated instruments. The Native American Indian Compliance Office shall be staffed by experts in the area of the business operations of financial services organizations, predominately with respect to matters concerning Native American Indian finance, namely, jurisdictional and tax-based sovereignty through the prohibition of the imposition of foreign levies on Native American Indian lands.

This interconnected system will result in a uniform financial instrument that is beneficial to exchange and trade and which has like qualities to those sold on the traditional markets, thereby promoting market-based liquidity. In addition, institutional association will be innately promoted by the partaking of various responsibilities among a host of participating financial organizations, thus generating increased operating and administrative consistency within the institutional association. By way of example, a financial services organization will put together a monetary security or instrument offering through the standardized format utilized by such institutional association.

Realization of the current invention commences a coordinated financial system between active financial services organizations that promotes the beneficial qualities of Native American Indian beliefs with respect to community improvement within a sovereign authority framework within a context of financial services practicality.

Further, such a Native American Indian compliant financial structure that does not permit for the imposition of foreign levies on activities on Native American Indian sovereign lands, enables the operation of a systematic mechanism having a pecuniary effect like to a conventional securitization or financial enhancement that would otherwise be precluded under Native American Indian financial guiding principles.

The current invention therefore injects into the Native American Indian economy a form of financial cohesiveness that does not presently appear amongst current financial practices. This system will spur further promotion of the Native American Indian financial economy, particularly the increased participation with respect to financial monitoring and disclosure of participating financial services organizations. The current invention encourages participating financial services organizations to assist in the monitoring of the actions of other participating financial entities and to disclose their own compliance and financial health for consideration and evaluation by allied organizations.

The desire for the financial unity of allied financial services organizations is a proven way in which to highlight the importance with respect to compliance and investment reporting between financial services organizations in the conventional marketplace. The evaluation of a financial services organization's standing is the typical way in which to demonstrate a performance-driven analysis so that the entity will be rapidly identified for reliable and consistent performance by its industry peers. An accurate presentation of the high-quality administrative, operational and financial practices demonstrated by a financial increases the breadth of the financial services industry's scope and ability, adds clout to such organization, improves associated credit ratings, facilitates business and cooperation in the financial markets and improves the quality and volume of investment products and offerings in the marketplace.

The financial services method formed in line with the current invention maintains a monitoring and disclosure system with respect to a Native American Indian compliant framework. The financial services methodology of the current invention encourages a desire for financial services entities to provide documentation relating to their financial services status and health that are in accordance with generally accepted practices in the conventional markets, combined with disclosures showing the Native American Indian compliant nature of such investment activities and financial instruments. Given the provision of these disclosures and reports, an advantageous financial instrument formed in conformity with the financial services method of the current invention described herein, will allow for the provision of credit service ratings of such participating financial organizations through the use of the rating criterion and investment philosophies of the conventional asset capital markets, combined with the particularly formulated rating activities which relate to issues of Native American Indian law and compliance.

A financial services method created in line with the standards of the current invention involves a wide array of systems which when combined, establish a methodology which solves the problems discussed earlier. A financial services method formed in conformity with the standards of the current invention creates numerous beneficial advancements that assist to fix the variety of practical difficulties of operating a Native American Indian financial market with services that the traditional markets have enjoyed for decades. The financial services method of the current invention establishes an internet-based, computerized communications and messaging system to provide assistance to the institutional association. Such system will foster financial trading and transactions involving financial instruments that will produce superior marketplace liquidity and efficiencies for financial services organizations and underlying nonresident alien investors. The financial method of the current invention permits the proficient underwriting, offering, placement and resale of qualifying financial instruments between participating Native American Indian financial services organizations, banks and underlying nonresident alien investors. The financial services method of the current invention promotes the beneficial operation of various Native American Indian compliant financial products that are systematically created so that a uniform financial instrument is formulated and traded. Such a security will not require to greatly differ given the planned utilization of revenues obtained from the placement or resale of the financial instrument involving the underlying investor. The financial method of the current invention improves efficiencies with respect to investment returns and generates a mechanism for use in the financial marketplace that is advantageous to the marketing of qualifying financial instruments, thus providing a measure of liquidity to the underlying investor. The financial method of the current invention promotes the rating of the financial instruments by established credit rating organizations and the advancement of the Native American Indian trading exchanges for such qualifying financial products. The financial method of the current invention encourages the utilization of financial services disclosure and monitoring standards utilized by the conventional marketplace, so that participating financial services organizations can continue to participate in the offering and sale of such qualifying financial instruments.

Through the creation of a complete financial and credit rating system formulated in conformity with numerous uniform financial and Native American Indian compliant criterion, the current invention provides for financial organizations and related financial instruments to be graded and assessed as compared to the financial reporting information disclosed, thereby providing for easier evaluation by financial institutions, underlying investors and the industry as a whole, as such improving the proficiency and productivity of the Native American Indian economy and investment market. In addition, through the utilization of the internet-based, computerized method, the current invention can serve as the operating basis for the formation of a uniform Native American Indian financial services exchange and marketplace.

These advantages demonstrate an evident requirement for a financial services method developed in line with the standards of the current invention to allow for the normalization and centralization of financial organization transactions within the Native American Indian financial services market. This will produce an economic environment for underlying investors with a heighted amount of liquidity, more substantive financial data and disclosures and more uniform financial products available for consideration by underlying investors. With respect to banking activities, the current invention will spur comprehensive financial reporting and disclosures by participating financial services organizations, develop coordinated inter-jurisdictional systems, policies and procedures, highlight various aspects of particular risks associated with the offering of such financial products, and allow for superior efficiency and consistency with respect to the evaluation of investment returns and compliance with Native American Indian investment guidelines of financial organizations, financial instruments and the underlying investors. The general theme here is one of consistency and normalization of a Native American Indian compliant financial system that develops advancements of the Native American Indian economy and financial services marketplace.

In order to clarify, and not to limit, the parameters of the current invention, what follows is a description of an example of a financial instrument formed in conformity with the standards of the current invention.

### EXAMPLE

Referring to FIG. 2, a schematic overview of a preferred embodiment of the systematic realization of a financial services method formulated in line with the standards of the current invention is exhibited. In a preferred embodiment, the system is the internet. In one embodiment, such system can be made up of two key parts: an internet browser and a server. The internet browser is mechanism separate and runs on various applications that have the ability of displaying certain HTML data such as Safari from Apple Corporation of Cupertino, Calif., Firefox from Mozilla Corporation of Mountain View, Calif. or Internet Explorer from Microsoft Corporation of Redmond, Wash. The computer server can be hosted from a network of systems available from Sun Microsystems of Santa Clara, Calif., Oracle Corporation of Redwood Shores, Calif. or Intel Corporation of Santa Clara, Calif., utilizing an system of operations from Apple Corporation, Mozilla Corporation or Microsoft Corporation. Such devices may be housed on distinct apparatuses or as a part of a network of servers. Different internet-based systems made up of additional computers utilizing various applications and systems of operations may be utilized to house the system of the current invention.

FIG. 2 schematically demonstrates a preferred embodiment of the systematic realization of the disclosing of information and evaluating of financial instruments contained in the financial system method formulated in line with the standards of the current invention. In a preferred embodiment, this methodology is hosted on an internet-based system distinct from the network that maintains the management and operation of the current invention. From the outset, various data concerning each planned financial instrument must be disclosed, including with respect to Native American Indian compliance, through the network which will collect and reformat the information into a standardized format for utilization in auditing and evaluating the qualifications of the financial investment, particularly with respect to Native American Indian compliance (1). The auditing and evaluation methodology will house such data in a uniform internet-based manner and issue frequent certifications with respect to each financial instrument and participating financial organization (2). The information is subsequently forwarded to the investment system via secure internet connection in an XML format (3).

While the current invention has been discussed with respect to certain embodiments, other variations, forms, modifications and possibilities will be evident to persons with requisite abilities in the art. As such, it is proposed to incorporate all such variations, forms, modifications and possibilities within the context of the character and range of the claims attached hereto.

The glossary below is provided for assistance only and not to narrow the scope of the current invention:

Glossary

Capital: monetary instruments that are convertible to United States dollars and personal property, including tangible personal property.

Financial entity or organization: the organization that offers the financial instruments, proffers an offering for the intended result of collecting funds and further implements and manages such sales and corresponding revenues of the financial instruments in a way that conforms with the subscription criterion devised to that particular offering under which said financial instruments were proffered.

HTML: hyper text markup language.

Indian: an enrolled member of a federally recognized Indian tribe.

Indian trust land: land owned by the United States in trust for an Indian tribe, a group of Indians, or an individual Indian.

Institutional association: the systematic network which embodies or otherwise constitutes the current invention.

Investment: the financial instrument or security which is the planned use of the subscription proceeds obtained from the sale of such investment.

Lending: letting out money for temporary use on condition of repayment or purchasing or discounting accounts receivable, notes, or installment obligations.

Monetary instruments: (i) coins or currency of any country; (ii) bank, business, cashier's, certified, personal, or traveler's checks; (iii) drafts, notes, or money orders or (iv) investment securities or negotiable instruments in bearer form or in such other form that title thereto passes upon delivery.

Nonresident alien investor: individuals or entities that are exempt from United States taxes, including residents of jurisdictions other than the United States and tax-exempt U.S. persons.

Offering: the manner in which investments are brought to the marketplace for acquisition by investors.

Offering circular: the certificate that affords a potential subscriber with the requisite disclosures and details concerning the character of the investments being proffered for subscription.

Person: an individual, association, company, corporation, partnership, or trust, an agency of federal, tribal, or state government or any other legal entity.

Rating organization: Fitch, Inc., One State Street Plaza, New York, N.Y., 10004 (“Fitch”), Standard & Poor's, 55 Water Street, New York, N.Y. 10041 (“S&P”), Moody's Investors Service, Inc., 7 World Trade Center, 250 Greenwich Street, New York, N.Y. 10007 (“Moody's”), or another renowned and qualified rating organization.

Tribal: of, or relating to, a Tribe.

Tribe: means a federally recognized Indian Tribe unless the context indicates otherwise, in which case that term means any federally recognized Indian tribe, band, community, nation, pueblo or village.

XML: extensible markup language.

What is claimed is:

1. The method of forming a financial instrument comprising:
producing or appointing an organization that sells financial products;
establishing a Native American Indian Compliance Office;
evaluating the planned financial instrument as to compliance with Native American Indian investment guidelines and practices;
having an rating organization provide the financial instruments with a credit rating;
offering the financial instrument to various qualified, nonresident alien subscribers that wish to invest in accordance with Native American Indian investment guidelines and practices; and
reviewing the financial instruments with respect to Native American Indian investment compliance.

2. The method of forming a financial instrument of claim 1, wherein the step of establishing a Native American Indian Compliance Office also includes the utilization of services of at least three duly certified and qualified Native American Indian investment experts.

3. The method of forming a financial instrument of claim 1, wherein the step of establishing a Native American Indian Compliance Office also includes the utilization of services of at least one expert specialized in the business operations of financial services organizations.

4. The method of forming a financial instrument of claim 1, wherein the step of evaluating the planned financial instrument as to compliance with Native American Indian investment guidelines and practices also includes the provision to the Native American Indian Compliance Office requisite disclosures that will afford the possible subscriber with thorough information concerning the details of the financial instruments proffered for investment and credentials concerning the status of the eligibility criterion concerning the investments and business operations of the issuing financial services organization.

5. The method of forming a financial instrument of claim 1, wherein the Native American Indian Compliance Office also includes advising, monitoring and supervising with respect to issues of compliance with Native American Indian investment guidelines and practices relating to the financial services organization's offering and sale of the financial instruments and continuing activities and operations, and financial interests relating to the computation and issuance of returns, financial risk controls and the issuance of the financial instruments.

6. The method of forming a financial instrument of claim 1, wherein after the step of evaluating the planned financial instrument as to compliance with Native American Indian investment guidelines and practices, the Native American Indian Compliance Office supplying official recognition of compliance with Native American Indian investment guidelines and practices.

7. The method of forming a financial instrument of claim 1, wherein the step of having an rating organization provide the financial instruments with a credit rating also includes obtaining ratings for the financial instruments by Fitch, Inc., One State Street Plaza, New York, N.Y., 10004 (“Fitch”), Standard & Poor's, 55 Water Street, New York, N.Y. 10041 (“S&P”), Moody's Investors Service, Inc., 7 World Trade Center, 250 Greenwich Street, New York, N.Y. 10007 (“Moody's”) or another renowned and qualified rating organization.

8. The method of forming a financial instrument of claim 1, further wherein the step of reviewing the financial instruments with respect to Native American Indian investment compliance also includes random inspecting and frequent auditing activities to ensure that such operations conform with Native American Indian investment guidelines and practices.

9. The method of forming a financial instrument of claim 1, further wherein the step of reviewing the financial instruments with respect to Native American Indian investment compliance also includes the annual production of financial information and a detailed report to the Native American Indian Compliance Office for review and inspection.

10. The method of forming a financial instrument of claim 1, further wherein the step of reviewing the financial instruments with respect to Native American Indian investment compliance also includes creating a current version of the Native American Indian official recognition of compliance available to current and potential qualified, nonresident alien subscribers.

11. The method of forming a financial instrument comprising:
maintaining currency for the purchase of the financial instrument from a subscriber in a depository bank account established for investment proceeds;
after confirmation of sufficient investment proceeds, placing currency for the purchase of the financial instrument in a Native American Indian compliant investment account or depository bank reserve account established for the holding and reservation of such funds; and
replacing the units of financial instrument interests with the currency held Native American Indian compliant investment account or depository bank reserve account for the benefit of the nonresident alien subscribers.

12. The method of forming a financial instrument of claim 11 further wherein the step of maintaining currency for the purchase of the financial instrument from a subscriber in a depository bank account established for investment proceeds also comprises:
in advance of approval of a subscriber, maintaining currency for the purchase of the financial instrument from such subscriber into a depository bank holding account established for the collection of investment proceeds; and
following approval of a subscriber, moving currency for the purchase of the financial instrument from the bank holding account into a depository bank proceeds account established for the collection of investment proceeds.

13. The method of forming a financial instrument of claim 11 also establishing a depository bank account established for the collection and expenditure of investment proceeds with respect to purchase of a financial instrument and moving the required currency to effectuate such investment from a depository bank reserve account to the investment account.

14. The method of forming a financial instrument of claim 13 also including withdrawing investment currency placed in the investment account for specific and direct purchase of certain financial instruments.

15. The method of forming a financial instrument of claim 14, further wherein the step of withdrawing investment currency placed in the investment account for specific and direct purchase of certain financial instruments also includes expending such portion of investment proceeds out of the investment account through an escrow, title or similar organization for the receipt of the financial service organization's designated financial instruments.

16. The method of forming a financial instrument of claim 14, further wherein the step of withdrawing investment currency placed in the investment account for specific and direct purchase of certain financial instruments also includes effectuating the expenditure of currency into qualifying investments through mechanisms subject to confirmation and audit, thereby ensuring that such investments conform with the strict criterion established and confirmed by the Native American Indian Compliance Office.

17. The method of forming a financial instrument of claim 11 also including establishing a Native American Indian Compliance Office and reviewing the financial instruments with respect to Native American Indian investment compliance.

18. The method of creating a financial instrument of claim 17, wherein the step of establishing a Native American Indian Compliance Office also includes the utilization of services of at least three duly certified and qualified Native American Indian investment experts.

19. The method of forming a financial instrument of claim 18, wherein the step of establishing a Native American Indian Compliance Office also includes the utilization of services of at least one expert specialized in the business operations of financial services organizations.

20. The method of forming a financial instrument of claim 17, wherein the step of evaluating the planned financial instrument as to compliance with Native American Indian investment guidelines and practices also includes the provision to the Native American Indian Compliance Office requisite disclosures that will afford the possible subscriber with thorough information concerning the details of the financial instruments proffered for investment and credentials concerning the status of the eligibility criterion concerning the investments and business operations of the issuing financial services organization.

21. The method of forming a financial instrument of claim 17, wherein the Native American Indian Compliance Office also includes advising, monitoring and supervising with respect to issues of compliance with Native American Indian investment guidelines and practices relating to the financial services organization's offering and sale of the financial instruments and continuing activities and operations, and financial interests relating to the computation and issuance of returns, financial risk controls and the issuance of the financial instruments.

22. The method of forming a financial instrument of claim 17, wherein after the step of reviewing the financial instruments with respect to Native American Indian investment compliance also includes creating a current version of the Native American Indian official recognition of compliance available to current and potential qualified, nonresident alien subscribers.

23. The method of forming a financial instrument of claim 11 also including having an rating organization provide the financial instruments with a credit rating.

24. The method of forming a financial instrument of claim 23, wherein the step of having an rating organization provide the financial instruments with a credit rating also includes obtaining ratings for the financial instruments by Fitch, Inc., One State Street Plaza, New York, N.Y., 10004 (“Fitch”), Standard & Poor's, 55 Water Street, New York, N.Y. 10041 (“S&P”), Moody's Investors Service, Inc., 7 World Trade Center, 250 Greenwich Street, New York, N.Y. 10007 (“Moody's”) or another renowned and qualified rating organization.

25. The method of forming a financial instrument of claim 11 also including reviewing the financial instruments with respect to Native American Indian investment compliance for the duration of the existence of the financial instruments.

26. The method of forming a financial instrument of claim 25, further wherein the step of reviewing the financial instruments with respect to Native American Indian investment compliance also includes random inspecting and frequent auditing activities to ensure that such operations conform with Native American Indian investment guidelines and practices.

27. The method of forming a financial instrument of claim 25, further wherein the step of reviewing the financial instruments with respect to Native American Indian investment compliance also includes the annual production of financial information and a detailed report to the Native American Indian Compliance Office for review and inspection.

28. The method of forming a financial instrument of claim 25, further wherein the step of reviewing the financial instruments with respect to Native American Indian investment compliance also includes creating a current version of the Native American Indian official recognition of compliance available to current and potential qualified, nonresident alien subscribers.

29. The method of forming a financial instrument of claim 11 also including disbursing currency into a depository bank account established for the collection and receipt of payments.

30. The method of forming a financial instrument of claim 29 also including moving the currency in the bank account to a depository bank payment account established for the holding and direct expenditure of all funds owed to the subscribers.

31. An internet-based computerized auditing and disclosing of a financial instrument comprising:
collecting pertinent Native American Indian investment compliance and financial disclosures from nonresident alien investors; and
computing and monitoring the compliance of every investment stemming from the sale of financial instruments.

32. The internet-based computerized auditing and disclosing method of a financial instrument of claim 31 also including channeling disclosures via a protected internet connection.

33. The internet-based computerized auditing and disclosing method of a financial instrument of claim 31 also including collecting the disclosures in a uniform internet-based format.

34. The internet-based computerized auditing and disclosing method of a financial instrument of claim 31 also including developing regular disclosures concerning investment data.
